(19) United States
(12) Patent Application Publication
(10) Pub. No.: US 2013/0136532 A1
(43) Pub. Date: May 30, 2013

(54) CYMBAL QUICK-RELEASE STRUCTURE

(71) Applicant: Tsun-Chi LIAO, Taichung City (TW)

(72) Inventor: Tsun-Chi LIAO, Taichung City (TW)

(21) Appl. No.: 13/305,121

(22) Filed: Nov. 28, 2011

(51) Int. Cl. F16B 1/00

(52) U.S. Cl. 403/327

(57) ABSTRACT

A cymbal quick-release structure includes a spindle, a coupling ring, a fastening cap, an elastic element and a latch ball. The spindle has an annular groove. The coupling ring is coupled on the spindle and has an outer flange, a latch ring, and an orifice. The latch ball is held in the orifice. The fastening cap is coupled with the coupling ring and has a projection confined between the outer flange and latch ring. The elastic element has two ends butting the projection and outer flange. The projection covers the orifice and pushes the latch ball to protrude outside the orifice to latch on the annular groove so that the coupling ring is fastened to the spindle. The fastening cap is movable to push the elastic element to shrink until the projection is separated from the orifice so that the latch ball escapes from the annular groove.

### FIELD OF THE INVENTION

The present invention relates to a musical instrument and particularly to a fastening structure for musical instruments.

### BACKGROUND OF THE INVENTION

A conventional musical instrument, such as a cymbal, drum or the like, has to be fastened first to an instrument stand 2 when in use, referring to FIG. 1. The instrument stand 2 generally is coupled with a connector 3 to hold the musical instrument.

Take a cymbal 1 as an example. The connector 3 has a fastening hole 4 at one end to receive the instrument stand 2. The fastening hole 4 is transversely screwed with a pressing fastener 5. When the instrument stand 2 runs through the fastening hole 4, the pressing fastener 5 is wrenched to press the instrument stand 2 for fastening.

The connector 3 has a bolt 6 at another end to screw with two adjustment rings 7 and two wool felts 8. The cymbal 1 can be sandwiched between the two wool felts 8, and then the bolt 6 is screwed via a nut 9 to tightly fasten the cymbal 1.

The two wool felts 8 aim to absorb noises generated when the cymbal 1 is percussed, and also prevent the cymbal 1 from hitting the instrument stand 2. The two adjustment rings 7 can be used to adjust the holding tightness of the cymbal 1. They also provide a double-screwing structure to avoid loosening.

However, in the event that removing the cymbal 1 from the instrument stand 2 is desired, the nut 9 has to be unfastened first, and then the cymbal 1 can be removed. These actions take a lot of time. Moreover, the nut 9 is prone to loosen off after a period of time due to vibration and shaking.

This changes the fastening tightness and results in alterations of the percussion tone of the cymbal 1.

### SUMMARY OF THE INVENTION

Therefore, the primary object of the present invention is to provide a cymbal quick-release structure that can be assembled and disassembled quickly and does not have loosening problem.

To achieve the foregoing object, the invention provides a cymbal quick-release structure which includes a spindle, a coupling ring, a latch ball, a fastening cap and an elastic element. The spindle has an annular groove on an outer surface thereof. The coupling ring is coupled on the spindle and has an outer flange at one end and a latch ring coupled on another end. The coupling ring also has an orifice corresponding to the annular groove.

The latch ball is held in the orifice and formed at a diameter greater than the length of the orifice. The fastening cap is coupled with the coupling ring and has a projection confined between the outer flange and latch ring. The elastic element has two ends butting the projection and outer flange. The projection covers the orifice and pushes the latch ball to protrude outside the orifice to latch on the annular groove. The coupling ring is fastened to the spindle. The fastening cap can be moved to push the elastic element to shrink until the projection is separated from the orifice, so that the latch ball can escape from the annular groove.

Therefore, with the latch ball protruded outside the orifice and latched on the annular groove, the coupling ring can be fastened to the spindle to latch a selected musical instrument. When removing the musical instrument is desired, the fastening cap is moved to push the elastic element to shrink until the projection is separated from the orifice, so that the latch ball can escape from the annular groove and the coupling ring can be separated from the spindle to allow the musical instrument to be removed. By controlling latching of the latch ball on the annular ring, a quick-release structure is formed without screwing. The loosening problem that might otherwise occur also can be prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional cymbal fastening structure.

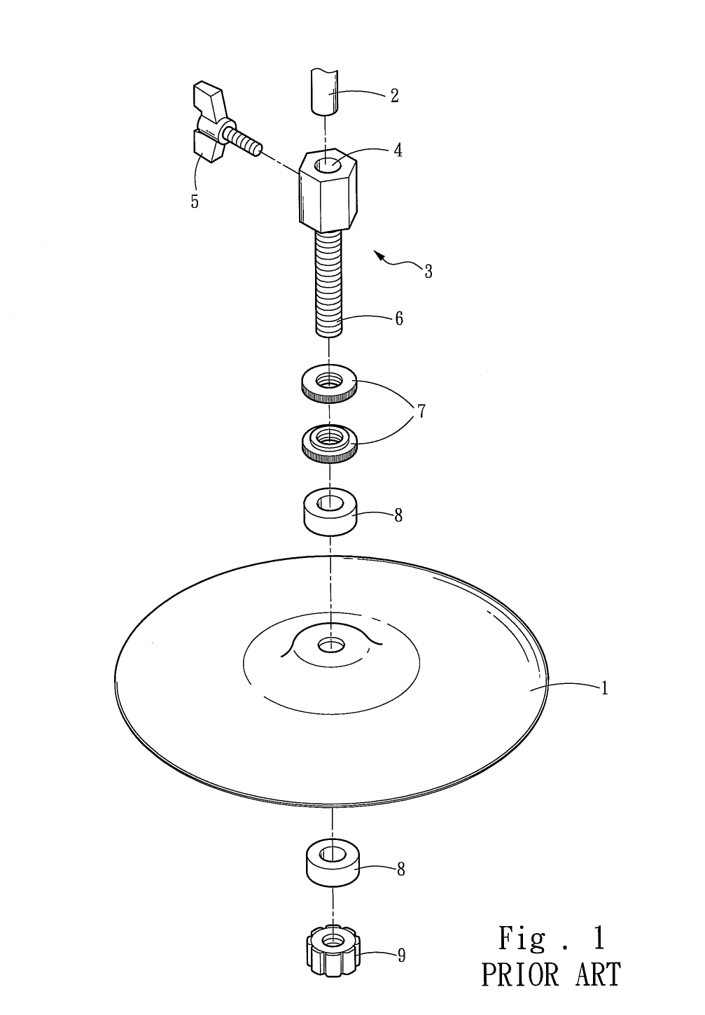

FIG. 2 is a fragmentary exploded view of the invention.

FIG. 3A is a fragmentary sectional view of the invention.

FIG. 3B is another fragmentary sectional view of the invention.

FIG. 4 is an exploded view of another embodiment of the invention.

FIG. 5 is a schematic view of the invention adopted on a cymbal.

FIG. 6 is a schematic view of the invention adopted on a congas.

### DETAILED DESCRIPTION OF THE PREFERRED EMBODIMENTS

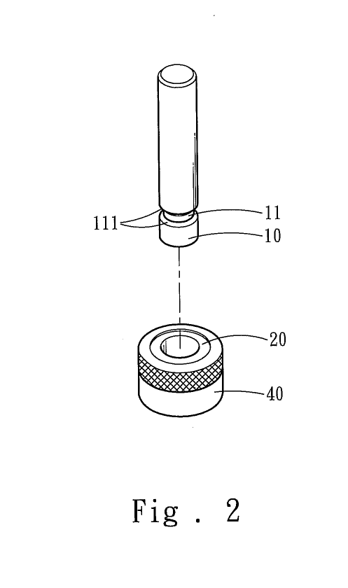

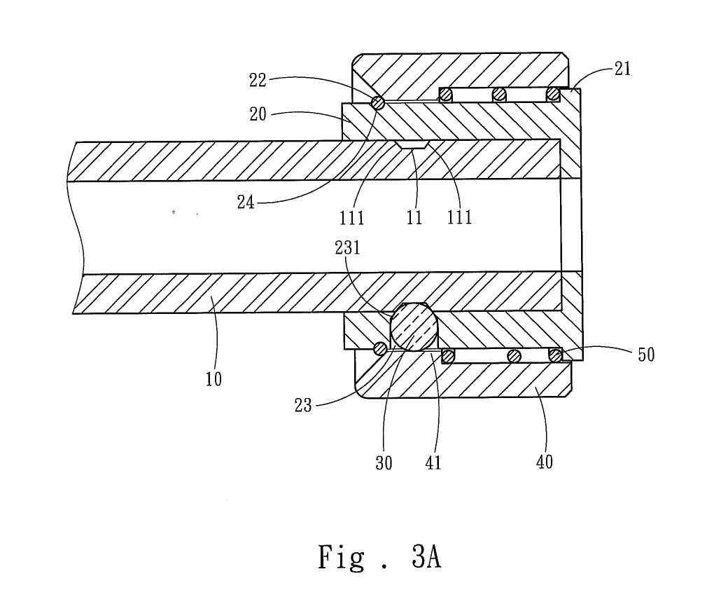

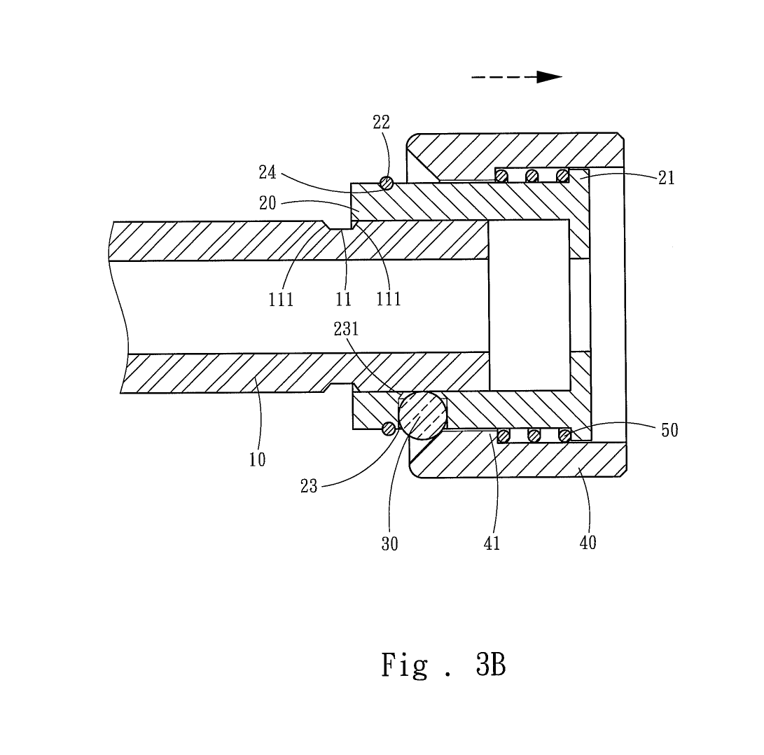

Please refer to FIGS. 2, 3A and 3B, the present invention aims to provide a cymbal quick-release structure which includes a spindle 10, a coupling ring 20, a latch ball 30, a fastening cap 40 and an elastic element 50. The spindle 10 has an annular groove 11 on an outer surface thereof. The annular groove 11 has two inclined sidewalls 111 opposing each other.

The coupling ring 20 is coupled on the spindle 10 and has an outer flange 21 at one end and a latch ring 22 coupled on another end. The coupling ring 20 also has an orifice 23 corresponding to the annular groove 11, and an outer slot 24 latched by the latch ring 22 to aid holding of the latch ring 22 without loosening off.

The latch ball 30 is held in the orifice 23 and formed at a diameter greater than the length of the orifice 23. The fastening cap 40 is coupled with the coupling ring 22 and has a projection 41 confined between the outer flange 21 and latch ring 22. The orifice 23 is tapered to form a conical opening 231 to latch the latch ball 30.

The elastic element 50 can be a compression spring and has two ends butting the projection 41 and outer flange 21. The projection 41 covers the orifice 23 and pushes the latch ball 30 to protrude outside the orifice 23 to latch on the annular groove 11 (referring to FIG. 3A), so that the coupling ring 20 can be fastened to the spindle 10. The fastening cap 40 also can be moved to push the elastic element 50 to shrink until the projection 41 is separated from the orifice 23, so that the latch ball 30 can escape from the annular groove 11 (referring to FIG. 3B), and the coupling ring 20 can be separated from the spindle 10.

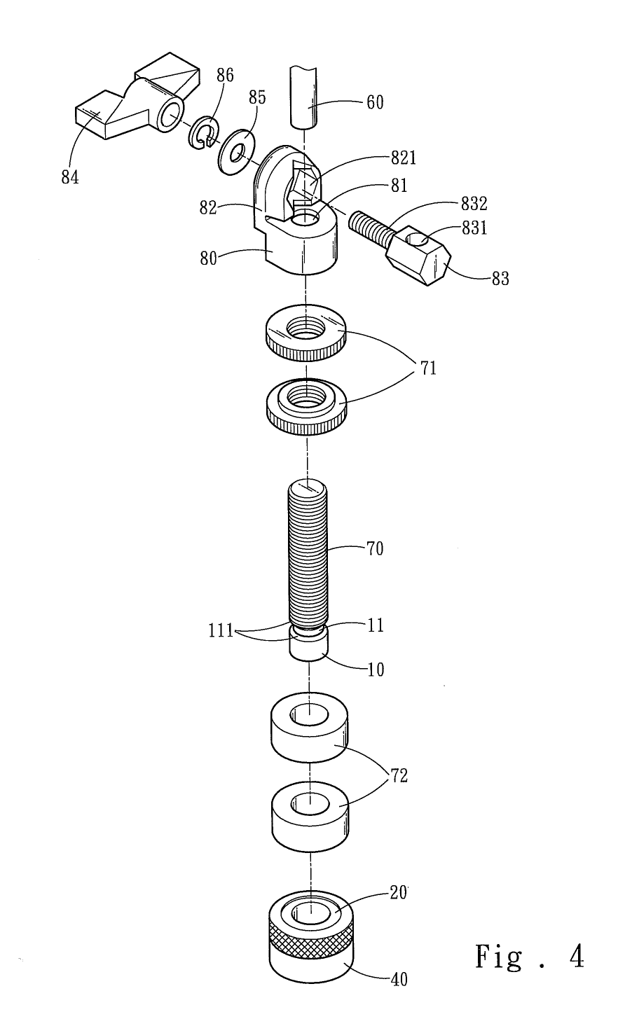

Also referring to FIG. 4, the invention can be used to fasten a musical instrument (not shown in the drawings) onto an instrument stand 60. The spindle 10 is connected to a bolt 70 which can be screwed with two adjustment rings 71 and two wool felts 72. The bolt 70 is fastened to a fastening head 80 which has a coupling hole 81 run through by the instrument stand 60 and an upright side plate 82 with a non-circular hole 821 run through by a pressing element 83 formed in a mating profile. The pressing element 83 has a pressing hole 831 and a screw bar 832 that are located at two sides of the upright side plate 82. The screw bar 832 is screwed with a wrench knob 84. The pressing hole 831 is aligned with the coupling hole 81. The screw bar 832 also is coupled with a detent washer 85 and a C-shaped clip 86 to prevent the wrench knob 84 from loosening off.

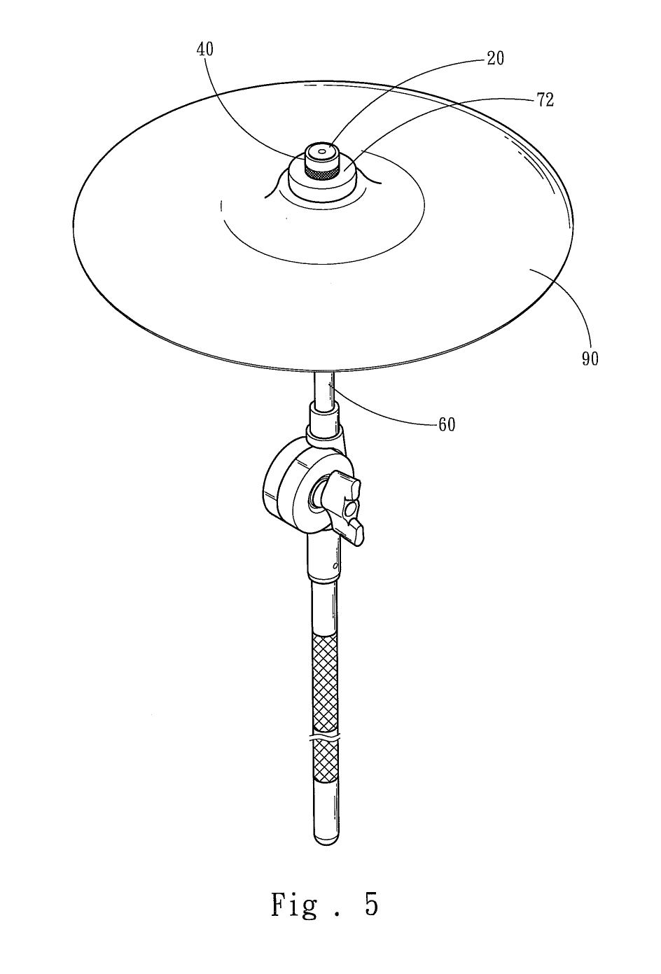

Also referring to FIGS. 4 and 5, the instrument stand 60 can be inserted into the pressing hole 831 and coupling hole 81, and then is fastened tightly by turning the wrench knob 84. To fasten a musical instrument, take a cymbal 90 as an example. The cymbal 90 is coupled on the bolt 70 between the two wool felts 72; next, the coupling ring 20 is coupled on the spindle 10 for fastening; and then the two adjustment rings 71 are adjusted to fasten the cymbal 90 tightly.

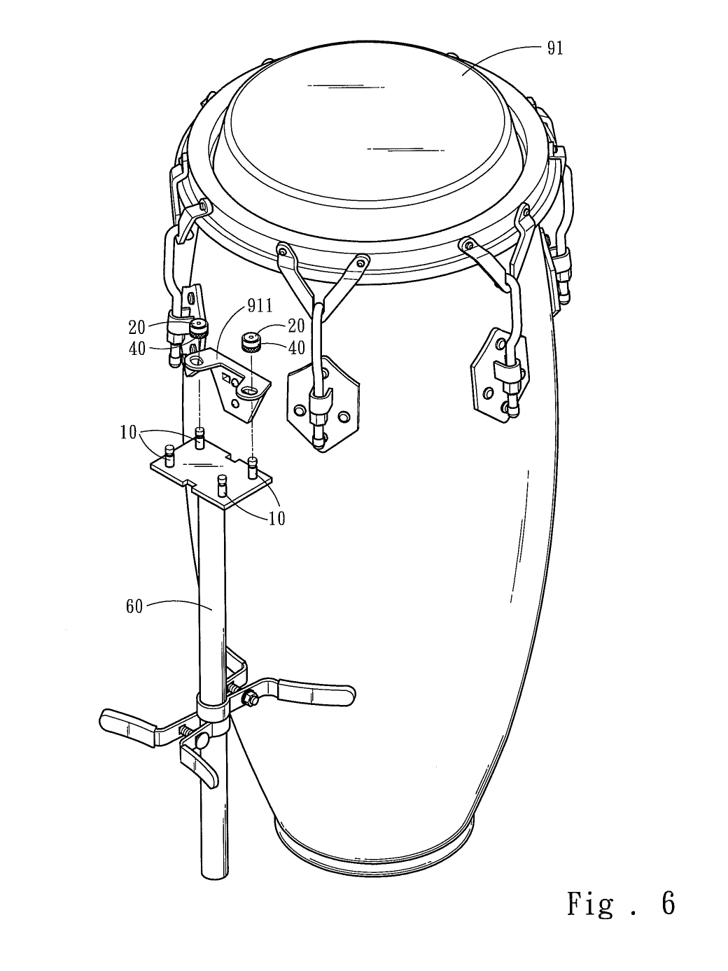

Referring to FIG. 6, the invention also can be used to fasten different types of musical instruments, take a congas 91 as an example. The instrument stand 60 has multiple sets of spindles 10. The congas 91 has a bracket 911 running through the spindles 10, and then the coupling ring 20 is coupled on each spindle 10 to further hold the congas 91 securely.

As a conclusion, by latching the latch ball 30 on the annular groove 11, a quick-release structure of the invention is thus formed. Simply coupling the coupling ring 20 to the spindle 10 can form secure fastening For disassembling, the fastening cap 40 is moved to push the elastic element 50 to shrink until the projection 41 is separated from the orifice 23, so that the latch ball 30 is returned into the orifice 23 to escape from the annular groove 11, and then the coupling ring 20 can be separated from the spindle 10. Thus fastening and unfastening can be done quickly, and the problem of loosening off also can be eliminated to meet requirements.

1. A cymbal quick-release structure, comprising:
a spindle including an annular groove on an outer surface thereof;
a coupling ring which runs through the spindle and includes an outer flange at one end and a latch ring coupled on another end and an orifice corresponding to the annular groove;
a latch ball held in the orifice and formed at a diameter greater than a length of the orifice;
a fastening cap which is coupled with the coupling ring and includes a projection confined between the outer flange and the latch ring, wherein the latch ring normally abuts on the projection; and
an elastic element which includes two ends butting the projection and the outer flange;
wherein the projection covers the orifice and pushes the latch ball to protrude outside the orifice to latch on the annular groove so that the coupling ring is fastened to the spindle; the fastening cap being movable to push the elastic element to shrink until the projection being separated from the orifice so that the latch ball escapes from the annular groove.

2. The cymbal quick-release structure of claim 1, wherein the annular groove includes two inclined sidewalls opposing each other.

3. The cymbal quick-release structure of claim 1, wherein the coupling ring includes an outer slot latched by the latch ring.

4. The cymbal quick-release structure of claim 1, wherein the orifice is tapered to form a conical opening to latch the latch ball.

5. The cymbal quick-release structure of claim 1, wherein the elastic element is a compression spring.

6. The cymbal quick-release structure of claim 1, wherein the spindle is connected to a bolt screwed with two adjustment rings and two wool felts.

7. The cymbal quick-release structure of claim 6, wherein the bolt is coupled with a fastening head which includes a coupling hole run through by an instrument stand and an upright side plate, the upright side plate including a non-circular hole run through by a pressing element formed in a mating profile, the pressing element including a pressing hole and a screw bar at two sides of the upright side plate, the screw bar being screwed with a wrench knob and the pressing hole being aligned with the coupling hole.

8. The cymbal quick-release structure of claim 7, wherein the screw bar is coupled with a detent washer and a C-shaped clip between the wrench knob and the upright side plate.
